(19) United States
(12) Patent Application Publication
(10) Pub. No.: US 2014/0297299 A1
(43) Pub. Date: Oct. 2, 2014

(54) MOBILE HEALTHCARE MANAGEMENT

(71) Applicant: MCKESSON FINANCIAL HOLDINGS, Hamilton (BE)

(72) Inventor: James D. Lester, IV, Atlanta, GA (US)

(73) Assignee: MCKESSON FINANCIAL HOLDINGS, Hamilton (BE)

(21) Appl. No.: 13/853,941

(22) Filed: Mar. 29, 2013

(51) Int. Cl. G06Q 50/22

(52) U.S. Cl. CPC G06Q 50/22; G06Q 10/0635
USPC 705/2

(57) ABSTRACT

Devices, systems, techniques, and computer-program products are provided for mobile healthcare management. In one aspect, a mobile device can acquire physiological information and/or situational information associated with a subject associated with the mobile device. The information that is acquired can be transmitted to a network platform and, based at least on the information that is acquired, a health profile associated with the subject can be generated and evaluated with respect to a reference health profile. Based at least on an outcome of the evaluation, in one aspect, a response to the health profile can be supplied to a healthcare provider. In scenarios in which the health profile is indicative of a medical emergency, the response can include an emergency communication with one or more first responder or a predetermined emergency contact for the subject. The reference health profile can be specific to the subject.

### BACKGROUND

Reimbursement models from payors of medical care (referred herein to as “payors”) to medical providers are changing in response to adoption of accountable care organizations (ACOs), value based reimbursement, shared risk, and other models for reimbursement and risk assessment. In addition, higher deductible plans are increasing patient liability. With these changing healthcare industry dynamics, medical care providers are likely to experience increased financial pressure.

### BRIEF DESCRIPTION OF THE DRAWINGS

FIGS. 1-2 illustrate example operational environments for mobile healthcare management in accordance with one or more aspects of the disclosure.

FIG. 3 illustrates an example health management unit in accordance with one or more aspects of the disclosure.

FIG. 4 illustrates an example radio unit in accordance with one or more aspects of the disclosure.

FIGS. 5A-5B illustrate another example health management units in accordance with one or more aspects of the disclosure.

FIG. 6 illustrates an example embodiment of a mobile device for mobile healthcare management in accordance with one or more aspects of the disclosure.

FIG. 7 illustrates an example operational environments for mobile healthcare management in accordance with one or more aspects of the disclosure.

FIG. 8 illustrates an example computing device for mobile healthcare management in accordance with one or more aspects of the disclosure.

FIGS. 9-11 illustrate example methods in accordance with one or more aspects of the disclosure.

### DETAILED DESCRIPTION

The disclosure recognizes and addresses, in one aspect, the issue of migration of financial risk from payors to medical care providers, and the marginal availability of solutions for active engagement of patients in their care episode. In addition, the disclosure recognizes that such migration can promote or otherwise incentivize medical care providers to become more engaged with their patients and associated health management, and monitor and measure the patients' health progress to ensure satisfactory outcomes for the health of the patient and the financial health of the medical provider. Accordingly, in one aspect, the disclosure provides pervasive, low-cost mobile based embodiments to monitor and measure a subject's health, including the detection of acute emergencies.

As described in greater detailed below, the disclosure provides mobile healthcare management that can permit or otherwise facilitate interactive care coordination between a medical care provider and a subject. In certain embodiments, a mobile device can acquire physiological information and/or situational information associated with a subject associated with the mobile device. The subject can be a subject under treatment (e.g., episodic care) or healthy subject. The mobile device can generate a response to the collection of such information. In one scenario, the response can include communication of care information to the subject. In another scenario, as a response, the mobile device can communicate at least a portion of the information that is acquired to a network platform that can generate a healthcare profile (also herein referred to as a health profile) associated with the subject based at least on the information that is communicated by the mobile device. In addition or in the alternative, the mobile device can communicate at least the portion of the information to a remote computing device associated with a medical care provider. The information that the mobile device can transmit to the network platform and/or the remote computing device can include longitudinal information obtained from historical collection of. The health profile can be evaluated with respect to a reference healthcare profile. The evaluation can comprise a comparison of the healthcare profile with the reference healthcare profile. Such evaluation can include, in one aspect, a determination of compliance with a health management plan. For example, the health management plan be or can include a protocol for episodic care (or an episodic care plan), a weight loss plan, a physiotherapy or rehabilitation program, or the like. In another aspect, the evaluation can include a determination of fulfillment of a criterion for satisfactory (e.g., optimal or nearly optimal) health management.

Based at least on an outcome of the evaluation, in one scenario, a response to the healthcare profile can be supplied (e.g., generated and transmitted) to the mobile device from the healthcare platform. In certain embodiments, such response can include one or more commands that can be executed by the mobile device in order to cause the mobile device to render predetermined information associated with the healthcare profile. In scenarios in which the healthcare profile is indicative or otherwise representative of a medical emergency, the response can include a command to initiate or to establish (e.g., to cause suitable exchange of control information for call session configuration) of an emergency communication between the mobile device and one or more first responder or a predetermined emergency contact for the subject. As an illustration, the medical emergency can be or can include an acute cardiac arrest, an acute renal failure episode, or an acute asthma attack. In addition, in one aspect, the response can include a command to transmit information that is specific to the medical emergency and/or that conveys the location of the subject.

A healthcare reference profile can be specific or otherwise customized to a subject (e.g., an episodic care patient). In one aspect, the network platform (which is herein referred to as a healthcare coordinator platform) can generate the reference health profile and/or a protocol for healthcare that can be associated with the reference health profile. The protocol for healthcare can be transmitted to a mobile device associated with the subject.

Embodiments of the disclosure can provide various advantages over conventional technologies for healthcare management and healthcare costs reimbursement. As an example advantage, certain embodiments can permit subject-specific customization of treatment or care and monitoring of subject responsiveness and/or adherence to the treatment. Such adjustment-response cycle can permit a degree of coordination that permits or otherwise facilitates shared risk type reimbursement models. As another example advantage, other embodiments can promote subject (e.g., patient) satisfaction because medical care providers can engage more effectively and efficiently with the subject. As yet another example advantage, some embodiments can permit acquisition and/or affiliation with physician groups for better management of episodes of care, with the ensuing better adaptation payors to non-conventional models for reimbursement of medical care costs.

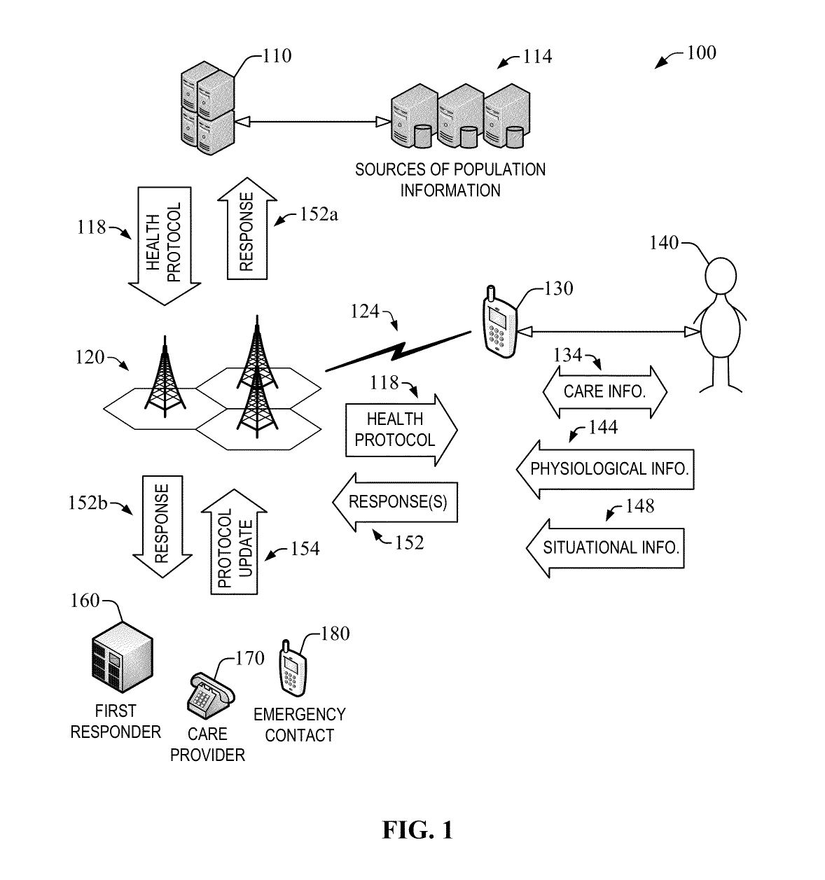

In connection with the drawings, FIG. 1 illustrates an example operational environment for implementation of mobile healthcare management in accordance with one or more aspects of the disclosure. A healthcare coordinator platform 110 can acquire (e.g., receive, collect, request and receive, a combination thereof, or the like) medical information for a population of subject from a group of one or more sources 114. The medical information can comprise information assets (e.g., tags, records, and/or data structures) comprising data, metadata, and/or signaling. In certain embodiments, the group of one or more sources 114 can include any combination of four sources of medical information, including a source of longitudinal clinical information assets; a source of pharmaceutical information; a source of evidence-based clinical information; and/or a source of infrastructure records for medical service interoperability. The longitudinal clinical information assets can include information indicative or representative of health condition evolution of a subject during a specific period—e.g., health condition during a pregnancy, health condition during diagnosis of a transplant need, pre-transplant clinical course, and post-transplant recuperation. The pharmaceutical information can include information indicative or otherwise representative of prescribed medications, allergies to specific substances or drugs, typical drug interactions for a subject's prescription profile (e.g., listing of medications and dosage for the subject), combinations thereof, or the like. The evidence-based clinical information can include demographic information (e.g., age information, gender information, ethnic background information, and/or weight information), efficacy of medical therapies, efficacy of lifestyle guidelines (e.g., diets), combinations thereof, or the like. The infrastructure records for medical service interoperability can include, for example, information for claim insurance reconciliation and/or fulfillment.

The healthcare coordinator platform 110 can process (e.g., aggregate) at least a portion of the medical information that is acquired. In one aspect of the processing, the healthcare coordinator platform 110 can identify specific medical information indicative or otherwise representative of health performance of a subject. The health performance can include health condition(s), extant comorbidity, commonly prescribed treatment plan(s) or therapy(ies), commonly recommended dietary restrictions, typically prescribed drug(s), common collateral effects of such drug(s), a combination thereof, or the like. In another aspect of the processing, the healthcare coordinator platform 110 can customize at least the portion of the medical information to a specific subject of the population of subjects. To at least such end, in one aspect, the healthcare coordinator platform 110 can identify a pattern of therapy-response for the specific subject. In another aspect, for such pattern, the healthcare coordinator platform 110 can determine likelihood of readmission for care. As an illustration, the portion of the medical information can be customized to a Caucasian male who is 49 years of age and has had a mild myocardial infarction, and is afflicted by hypertension and elevated low-density lipoprotein (or “bad cholesterol”).

Based at least on the information that is processed, the healthcare coordinator platform 110 can generate a reference health profile (also referred to as reference subject profile 118 or reference profile 118) for a specific subject and/or a healthcare protocol 118 (also referred to as health protocol 118). It should be appreciated that the reference health profile can comprise medical information. In certain embodiments, the reference profile can comprise one or more of a metric indicative of a health condition of the specific subject, a protocol for episodic care, a criterion for satisfactory episodic care, or a criterion for presence of a medical emergency. As illustrated, the healthcare coordinator platform 110 can communicate the health protocol 118 to a remotely located mobile device 130 associated with the specific subject. The health protocol 118 can be communicated via one or more networks 120, where at least one of such networks can be wirelessly functionally coupled to the mobile device 130 via a wireless data and signaling pipe 124.

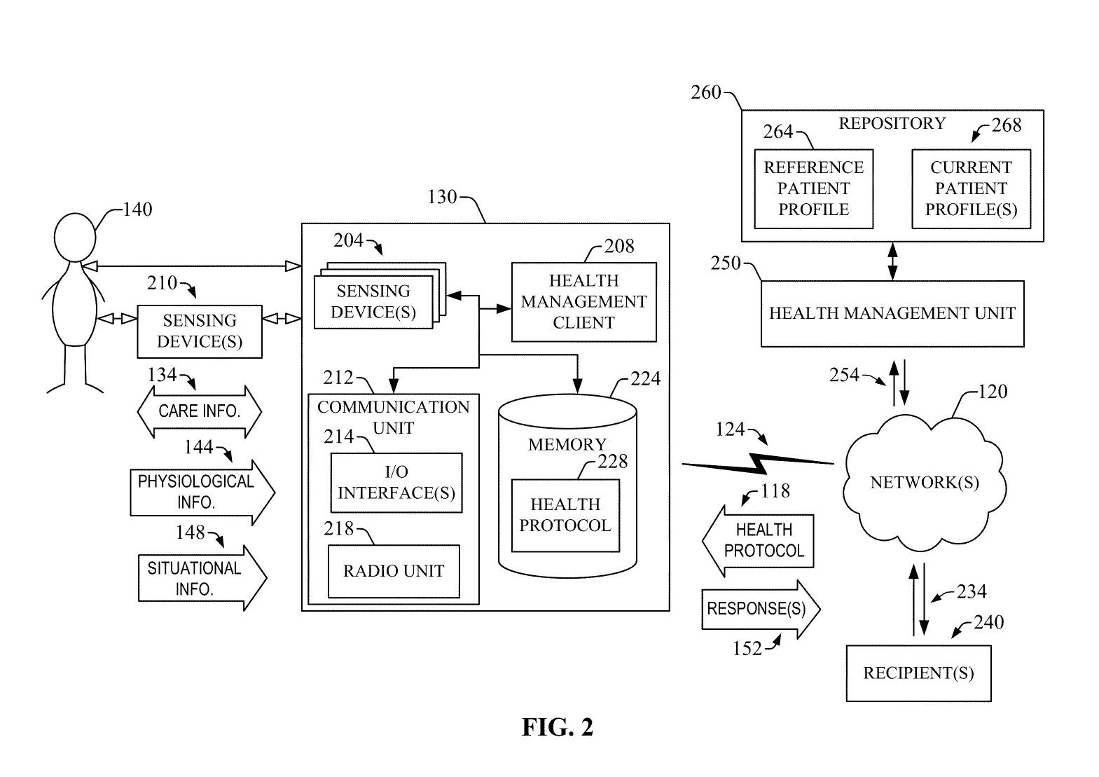

The mobile device 130 can be embodied in or can comprise a mobile computer, such as a tablet, or a smartphone; a gaming console; a mobile telephone; or a wearable computing device. The mobile device 130 can have specific computational resources, such as one or more processors and one or more memory devices (or memory(ies)) functionally coupled to the one or more processors. Computer-accessible instructions (e.g., computer-readable and/or computer-executable instructions) contained or otherwise encoded into the one or more memories can configure the one or more processors for operation in accordance with one or more aspects described herein. In addition, the mobile device 130 can be associated with a subject 140 that is associated with the health protocol 118, and can receive (e.g., collect and decode) and configure the health protocol 118. In one embodiment, e.g., embodiment 200 illustrated in FIG. 2, the mobile device 130 can comprise a communication unit 212 that can be configured to receive medical information wirelessly from a remote computing device, such as a network node in the network(s) 120. In one aspect, the communication unit 212 can receive the health protocol 118 and can communicate such protocol to a healthcare management unit 208 that can decode or otherwise access the information received in the health protocol 118 and can retain such information in a memory element 228 (labeled reference patient profile 228) within the memory 224.

Based at least in part on the health protocol 118, the mobile device 130 can interact with the subject 140. To at least such end, in one scenario, the mobile device 130 can convey care information 134 comprising at least a portion of the health protocol 118 (or plan for healthcare management). In one aspect, the mobile device 140 can render indicia indicative or otherwise representative of a caloric intake limit regulated or otherwise dictated by the health protocol 118. In another aspect, the mobile device 130 can render indicia indicative or otherwise representative of foodstuffs or dietary options for a specific meal (e.g., breakfast, lunch, or dinner) or snacks. In yet another aspect, the mobile device 140 can render indicia indicative or otherwise representative of a scheduled intake of a medication. In still another aspect, the mobile device 130 can render indicia indicative of a scheduled exercise activity (e.g., a 20-minute brisk walk, a 35-minute strength training with weights, both of the foregoing, or the like). Similarly, the mobile device 130 can receive at least a portion of the care information 134 from the subject 140. In certain embodiments, e.g., embodiment 200 illustrated in FIG. 2, the mobile device 130 can comprise one or more I/O interfaces 214 that can comprise at least one rendering unit that can render such indicia in response to an instruction or command received from the health management unit 208. The at least one rendering unit can comprise one or more of a display unit, a speaker, a vibration device, or the like.

The mobile device 130 can include one or more sensing devices that can acquire at least one of physiological information 144 indicative of health condition of the subject 140 or situational information 148 indicative of behavior of the subject 140. In certain scenarios, the physiological information 144 and/or the situational information 148 can be acquired in accordance with (e.g., as regulated by) at least the health protocol 118 or a plan for health management therein. In other scenarios, one or more of the physiological information 144 or the situational information 148 can be acquired in response to an event, which can be specific to the subject 140, and/or to a request from the subject 140. It should be appreciated that, in certain embodiments, the mobile device 130 can receive a configuration instruction or command to override information acquisition via at least one of the one or more sensing devices.

The one or more sensing devices can include at least one of a camera, a microphone, an accelerometer, a gyroscope, a thermometer, a combination thereof, or the like. At least one of such sensing device(s) can be integrated into the mobile device 130. In addition or in the alternative, the mobile device 130 can be functionally coupled (e.g., communicatively coupled) to one or more external sensing devices. In certain scenarios, an external sensing device can have higher architectural complexity and more specific functionality than a sensing device that is integrated into the mobile device 130. For example, an external sensing device can be embodied in or can comprise a glucose meter (or glucometer), a blood pressure monitor, and/or a blood analysis unit. As illustrated in example embodiment 200 shown in FIG. 2, the mobile device 130 can comprise one or more sensing devices 204 that can be integrated into the mobile device 130. In addition, the mobile device 130 can be functionally coupled to one or more external sensing devices 210. At least one of the external sensing device(s) 210 can be functionally coupled to the mobile device 130 via at least one of the I/O interface(s) 214, which can comprise at least one network adapter and/or at least one peripheral adapter (such as a universal serial bus (USB) connector).

Based at least on the health protocol 118 (or the plan for health management) and one or more of a portion of the physiological information 144 or a portion of the situational information 148 that is acquired, the mobile device 130 can generate one or more responses 152. Such responses can comprise information indicative or otherwise representative of health performance of the subject 140. For example, at least one response of the response(s) 152 can include at least a portion of the physiological information 144 and at least a portion of the situational information 148. In certain implementations, In other implementations, the mobile device 130 can configure information (e.g., data, metadata, and/or signaling) contained in a response of the response(s) 152 in a format that is suitable for comparison with like information in a reference profile at the network platform 110. As illustrated, at least two communication pathways are contemplated for the response(s) 152: (1) A response 152a can be transmitted to the network platform 110 from the mobile device 130 via the network(s) 120, or (2) a response 152b can be transmitted to one or more remote devices (e.g., computing devices and/or communication devices) associated with one or more of a first responder, a care provider, or an emergency contact of the subject 140. Such pathways can be referred to as reporting pathways.

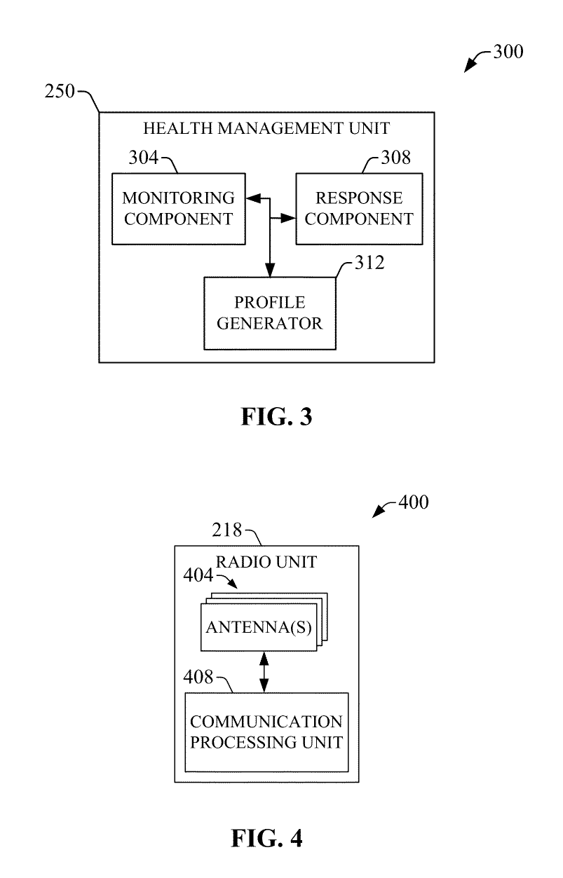

The network platform 110 can receive at least a portion of the information contained in the response(s) 152 and can generate a current patient profile (or current profile). In addition, the network platform 110 can evaluate or otherwise benchmark the current profile with respect to a reference profile that can be available for the subject 140. For instance, the network platform 110 can compare the current profile with the reference profile. In certain implementations, the evaluation can include a determination of a trends for a certain biometric, such as heart rate, blood glucose concentration, or blood pressure, and a comparison of the trend of the biometric with a predetermined range of satisfactory values for the biometric. As utilized herein, a trend can comprise a non-empty set of values obtained over a specific period. In certain embodiments, e.g., example embodiment 200 shown in FIG. 2, the mobile device 130 can comprise a client unit (e.g., health management client 208) that can control or otherwise administer at least one of the sensing device(s) 204 in order to acquire physiological information 144 and/or situational information 148 (e.g., information contained in a barcode or quick response code (QRC) placed on a label of a foodstuff). The health management client 208 can control or otherwise regulate the sensing device(s) 204 based at least in part on the health protocol 118, which can be retained in a memory element 228 in a memory 224. As described herein, the health management client 208 can transmit or can cause the mobile device 130 to transmit the response(s) 152 to a health management unit 250 (e.g., an application server) that can be deployed or otherwise functionally coupled to the healthcare coordinator platform 110. The health management unit 250 can generate a current profile for the subject 140 based at least in part on information conveyed in the response(s) 152. The health management unit can retain the current profile in a memory element (e.g., current patient profile(s) 268) within a memory device (e.g., repository 260) contained within or functionally coupled to the health coordinator platform 110. As illustrated, such memory device can contain a reference patient profile 264 that can server as the benchmark for a current patient profile generated by the health management unit 250. In certain implementations, the health management unit 250 can generate a current profile in nearly real-time, according to a schedule, and/or based on an event (such as an end-user request). To at least such end, in certain scenarios, the health management unit 250 can communicate a command to the health management client 208 to probe or otherwise collect specific physiological or situational information. In turn, the health management client 208 can received the command and direct or otherwise cause at least one sensing device (e.g., one or more of sensing device(s) 204) to collect the desired physiological information and/or situational information. The command can be referred to as a monitoring command and the schedule can be referred to as a monitoring schedule. In one embodiment, such as example embodiment 300 illustrated in FIG. 3, the health management unit 250 that communicates the monitoring command can include a monitoring component 304 that can generate the command in nearly real-time, according to a schedule, a reference patient profile, a plan for healthcare management, and/or based on a specific event. In addition, the monitoring component 304 can transmit the monitoring command (e.g., a computer-executable instruction) to the health management client. In one implementation, a memory device (e.g., the memory 224) can contain the monitoring schedule and/or monitoring logic (e.g., a group of computer-accessible instructions that, in response to execution, can cause the monitoring logic to supply (e.g., generate, transmit, generate and transmit) a monitoring command. In addition, as illustrated in the example embodiment 300, the health management unit 250 can include a profile generator 312 that can generate one or more of a reference patient profile or a current patient profile.

In addition, as illustrated in FIG. 1 and described herein, the mobile device 130 can generate one or more responses 152 (such as an episodic care report) comprising information indicative of an outcome of a comparison of collected physiological information and or situational information with respect to predetermined metric(s) (biometrics, satisfactory caloric levels, etc.) contained in the health protocol 118. The outcome of the evaluation (e.g., a comparison of the current profile with the reference profile 118) can comprise an indication that a criterion for satisfactory health management (e.g., satisfactory episodic care, satisfactory weight loss, satisfactory physiotherapy, or the like) is satisfied or an indication that the criterion for satisfactory episodic care is not satisfied. In the foregoing scenario, the indication(s) can be embodied in or can comprise a metadata object, such as an extensible markup language (XML) tag, indicative of compliance or lack thereof with the criterion for satisfactory (e.g., optimal or nearly optimal) health management.

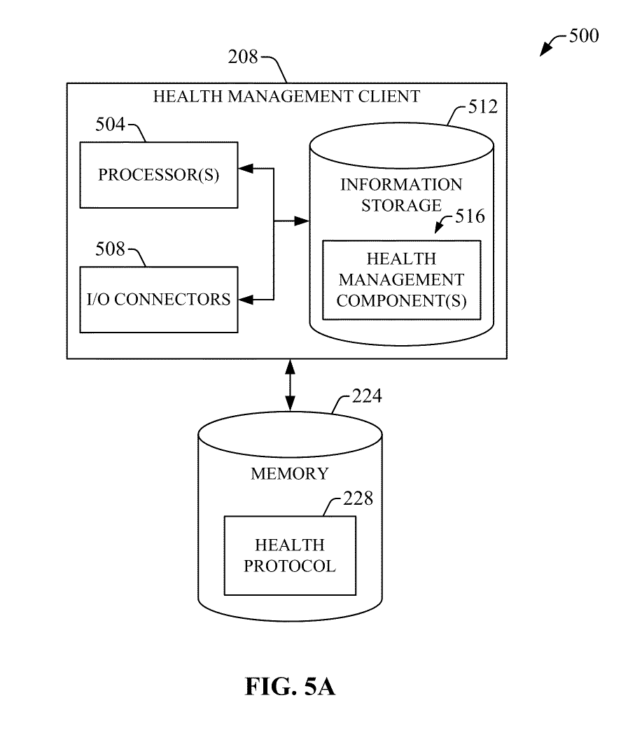

In one aspect, the response(s) 152 is an information asset that can be leveraged for various utilities. In one aspect, the response(s) 152 can be retained (e.g., stored in a memory device or storage device, such as memory 224) at the mobile device 130 and/or at the network platform 110 (e.g., at the repository 260) in order to generate historical (or longitudinal) records indicative or representative of responsiveness of the subject 140 to the health protocol 118 (e.g., a plan for health management). For example, the historical records can convey efficacy of a specific therapy for the subject 140. In addition or in the alternative, within one of the reporting pathways contemplated herein, the mobile device 130 can transmit the response 152 to a remote computing device associated with a medical care provider 170 (e.g., a physician, a nurse, a personal trainer, or the like) for the subject 140. In embodiment 200 illustrated in FIG. 2, for example, the health management unit 208 can communicate an instruction or command to the radio unit 218 to transmit, via the network(s) 120, the response 152 to one or more remote computing devices 240, referred to as recipient(s) 240. The radio unit 218 can permit, at least in part, the mobile device 130 to communicate wirelessly. To at least such end, in one aspect, the radio unit 218 can process wireless signal (e.g., electromagnetic signals) in accordance with one or more radio technology protocols. The mobile device 130 can operate in a variety of wireless environments having wireless signals conveyed in different electromagnetic radiation (EM) frequency bands. In certain embodiments, such as example embodiment 400 illustrated in FIG. 4, the radio unit 218 can include one or more antennas 404 and a communication processing unit 408. Electronic components and associated circuitry in the communication processing unit 408 can permit or otherwise facilitate processing and manipulation, e.g., coding/decoding, deciphering, and/or modulation/demodulation, of wireless signal(s) received by the mobile device 130 and wireless signal(s) to be transmitted by the same. In one aspect, received and transmitted wireless signals can be modulated and/or coded, or otherwise processed, in accordance with one or more radio technology protocols (e.g., 3rd Generation Partnership Project (3GPP) Universal Mobile Telecommunication System (UMTS), 3GPP Long Term Evolution (LTE), or the like). In addition or in the alternative, the communication processing unit 408 can permit the radio unit 218 to operate in multiple communication modes through various radio network technologies (e.g., second generation (2G), third generation (3G), fourth generation (4G)) or deep-space satellite-based communication in accordance with disparate technical specifications (or standard protocols) for the radio network technologies or such a satellite communication. In addition or in the alternative, in certain embodiments, the mobile device 130 can communicate wirelessly via an optically-switched mechanism, which can include electronic components and associated circuitry for wireless communication according to an optically-switching protocol (e.g., point-to-point optically-switched protocol) for processing (e.g., encoding, modulating, upconverting, downconverting, etc.) information.

In one aspect, communication or reporting of the response(s) 152 can produce a response from the medical care provider 170, which can communicate an updated protocol for care management (referred to as protocol update 154) to the mobile device 130. In certain embodiments, the protocol update 154 can be provided to the healthcare coordinator platform 110, which can update a reference profile associated with the subject 140. In either scenario, the mobile device 130 can receive the protocol update 154. Exchange of the response 152 and the protocol update 154 can permit interactive health management between the subject 140 and the medical care provider 170.

In other embodiments, the response(s) 152 can include a request for a prescription associated with the protocol for health management. In one aspect, the request can be transmitted to the healthcare coordinator platform 110, which can relay the request to a fulfillment platform or fulfillment server that can cause a pharmacy to refill an extant prescription or issue a new prescription.

As described herein, in certain scenarios, the physiological information 144 and/or the situational information 148 can be acquired in response to an event that is associated with the subject 140 and/or a request from the subject 140. For example, in one such scenario, the subject 140 can be exercising per his rehabilitation program after a particular procedure (e.g., total knee replacement or hip replacement. The subject 140 can be exercising alone and, during the exercising session (e.g., a brisk walk in an outdoor trail), the subject 140 can feel faint and lightheaded, and can experience shortness of breath. Such symptomatology can embody or otherwise represent the event that is associated with the subject 140. In response, the subject 140 can sit on the floor. In addition or in the alternative, the subject 140 can utilize the mobile device 130 (e.g., an IPHONE™, an ANDROID™ phone, or an IPAD™ tablet) to acquire the physiological information 144, such as information indicative of pulse and/or information obtained in response to scanning the subject's retina, or the situational information 148, such as aural information obtained from utterances and/or speech recorded into the mobile device 130. In certain embodiments, such situational information can be acquired from a microphone integrated into or otherwise functionally coupled to the mobile device 130, and can be analyzed with a speech analysis component (e.g., a voice recognition tool with stress level assessment) contained in the mobile device 130. Further, the subject 140 can pass out after or during acquisition of the physiological information 144 or the situational informaiton 148. In one of such embodiments, e.g., example embodiment 300 shown in FIG. 3, the monitoring component 304 can embody or can include the speech analysis component.

In the scenario described in connection with FIG. 1, the mobile device 130 can communicate the physiological information 144 that is acquired and/or the situational information 148 that is acquired to the network platform 110, which can generate a current profile and can evaluate it with respect to a reference profile. An outcome of the evaluation can be compared with a criterion for presence of a medical emergency condition of the subject 140. In certain embodiments, such criterion can be retain at a repository integrated into or functionally coupled to the network platform 110. For example, in the light of the reference profile, biometric values of readings derived from the physiological information 144 can indicate or otherwise convey that the subject 140 is in acute cardiac arrest. For another example, in the light of the reference profile 118, such biometric values of readings derived from the physiological information 144 can indicate or otherwise convey that the subject 140 is in acute renal failure. It should be appreciated that, in one aspect, the criterion for presence of a medical emergency condition can be specific or otherwise customized to the subject 140 via the reference profile associated with the subject 140. Accordingly, different subjects can have different criteria for presence of a medical emergency, and evaluation of the same physiological information 144 for the respective subjects may or may not convey presence of the medical emergency. Such subject specificity can be afforded by the rich medical information provided by the plurality of sources of medical information and utilized or otherwise leveraged by the healthcare coordinator platform 110 to produce the reference profile.

The foregoing evaluation and comparison can permit detection of a medical emergency. In response to presence of a medical emergency condition for the subject 140, the healthcare coordinator platform 110 can transmit an instruction or a command to the mobile device 130 to initiate, without human intervention (or automatically), for example, an emergency communication session (e.g., a voice call or a non-voice call) with a predetermined recipient device. It should be appreciated that such emergency communication session can be included in the response(s) 152. The predetermined recipient device can be associated with a first responder 160, a medical care provider 170, or an emergency contact 180, such as a relative or friend of the subject 140. For example, in response to the instruction of command received from the mobile device 130 can initiate a voice call to 911, where the voice call can convey at least information indicative of the medical emergency condition. The voice call also can convey location (e.g., latitude and longitude) of the subject 140. For another example, in response to the instruction or command, the mobile device 130 can initiate a non-voice communication session with predetermined recipient device. The communication session can be embodied in, for example, a short message service (SMS) communication, a multimedia message service (MMS) communication, an email communication, an unstructured supplemental service data (USSD) communication, or the like, and can convey at least information indicative of the medical emergency condition and location of the patient. In the example embodiment 300 illustrated in FIG. 3, the response component 308 can apply a rule or otherwise evaluate a criterion for presence of a medical emergency and, in response to ascertaining that the medical emergency is present, the response component 308 can generate a directive (e.g., a computer-executable instruction or command) to initiate or establish an emergency communication session. In addition, the response component 308 can transmit the directive to the mobile device 130.

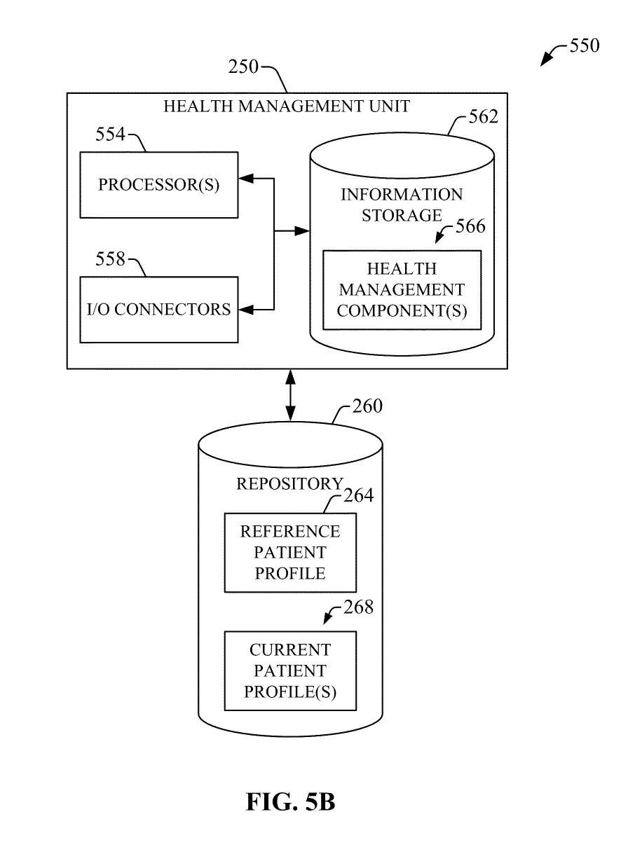

In connection with FIG. 5A, an example firmware embodiment 500 of the health management client unit 208 is illustrated. In such embodiment, the health management client unit 208 comprises one or more processor(s) 504 functionally coupled to information storage 512. Such storage can retain one or more memory elements 516 (referred to as health management component(s) 516) that can program one or more of the processor(s) 504 to operate in accordance with the various functional aspects described herein. For instance, the health management client unit 208 can perform various methods described herein in response to execution of the health management component(s) 516.

In connection with FIG. 5B, an example firmware embodiment 550 of the health management unit 250 is illustrated. In such embodiment, the health management unit 250 comprises one or more processor(s) 554 functionally coupled to information storage 562. Such storage can retain one or more memory elements 566 (referred to as health management component(s) 566) that can program one or more of the processor(s) 554 to operate in accordance with the various functional aspects described herein. For instance, the health management unit 250 can perform various methods described herein in response to execution of the health management component(s) 566.

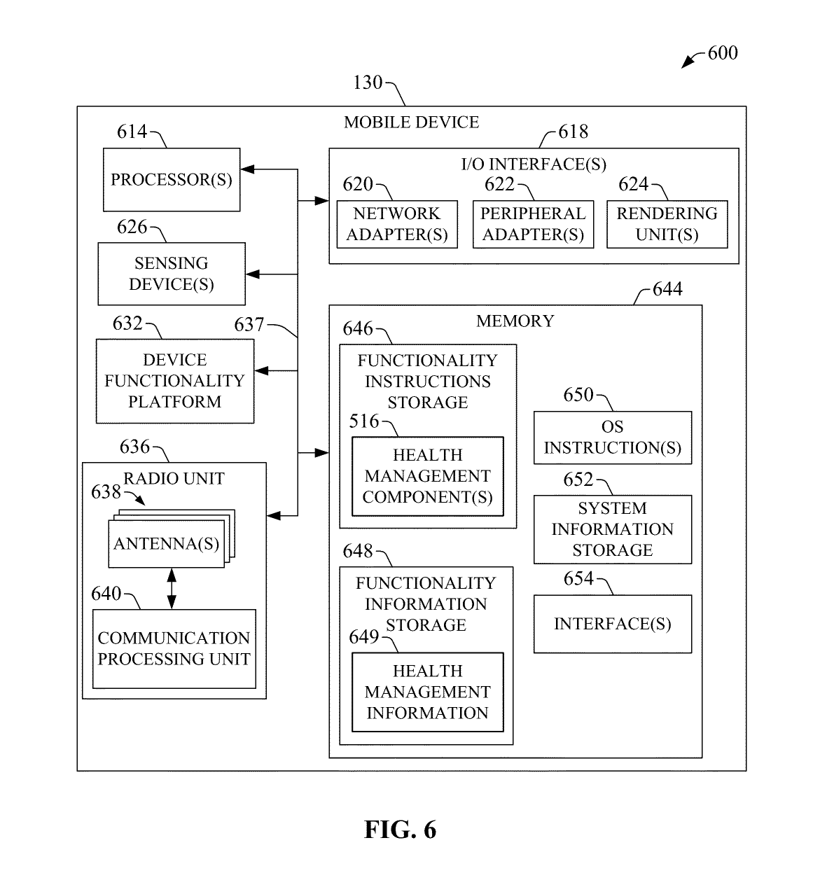

FIG. 6 illustrates a block-diagram of an example embodiment 600 of the mobile device 130 that can communicate and/or operate in accordance with at least certain aspects of the disclosure. As illustrated, the device 610 is a computing device in that it includes computational resources, such as processor(s) 614 and a storage device 644 (also referred to as memory 644). As described herein, the mobile device 130 can comprise user equipment, including wearable devices. As illustrated, the mobile device 130 can include one or more sensing devices 626 that, among other functionality, can detect or can be configured to detect motion of the mobile device 130. For example, as described herein, the sensing device(s) 626 can include an accelerometer, a gyroscope, a camera, a microphone, a combination thereof, or the like. In one aspect, the gyroscope can detect or otherwise collect and/or supply information indicative of positioning (e.g., rotation) of the mobile device 130. Such information can permit the mobile device to operate as pedometer. In addition, information collected by the gyroscope can permit determining stress level of a person associated with the device. Such a determination can be performed by establishing an inhalation/exhalation cycle and assessing whether such cycle corresponds to presence or absence of stress. In certain embodiments, the accelerometer and the gyroscope can be embodied in or can include solid states devices (such as microelectromechanical system (MEMS)) that can measure or otherwise collect information indicative of motion of the mobile device 130. In addition or in the alternative, the sensing device(s) 626 can include a gyroscopic compass or other type of compass.

The mobile device 130 can have specific functionality, which can be provided by a device functionality platform 632. In an embodiment in which the device 610 embodies or includes a medical device that collects information indicative of or otherwise measures a physical condition, such as blood pressure, heart rate, glucose concentration and/or a toxin in blood, and the like, of an end-user, the device functionality platform 632 can include circuitry, structure (e.g., electrodes, microfluidic channels, or reactants, etc.), and/or chemicals or other materials suitable for collecting information indicative of or otherwise measuring the physical condition. In such an embodiment, the medical device can be a wearable device. In other embodiments, the device 610 can embody or can include a gaming console, an electronic book reader (or e-reader), or a multimedia composition device, such as a camera. In such embodiments, the device functionality platform 632 can include circuitry and/or structure (e.g., memory components) suitable for permitting gaming, reading, or generation of media assets (e.g., photos, video segments, and the like).

It should be appreciated that, based at least on the specific functionality of the mobile device 130, the device functionality platform 632 can incorporate, supplement, and/or complement at least one of the input/output (I/O) interface(s) 618. In addition, the device functionality platform 632 can operate in conjunction (e.g., concurrently or sequentially) with other functional elements of the mobile device 130, such as the radio unit 636, and/or the sensing device(s) 626. For example, various functional elements and associated circuitry that can embody the device functionality platform 632 can permit data input through one or more gestures (e.g., touch, speech, motion), or one or more communication protocols. Such functional elements can include a keypad, a touch screen, a microphone, a camera, a bar code reader, a radio frequency ID (RFID) reader, an infrared (IR) wireless-based reader, or the like.

As described herein, the mobile device 130 can operate as a wireless device and can embody or can comprise a communication device of the disclosure. To permit wireless communication with a device (e.g., device 160), in one aspect, the mobile device 130 includes a radio unit 636 that has substantially the same architecture as the radio unit 218 and can operate in a similar manner as the radio unit 218.

As illustrated, the mobile device 610 comprises one or more processors 614 that can permit, at least in part, the functionality of one or more functional elements of the mobile device 130 as described herein. While in the example embodiment 600, the one or more processors 614 are illustrated as external to the various functional elements (e.g., component(s), interface(s), platform(s), node(s)) of the device 610, in an additional or an alternative embodiment, the one or more processors 614 can be distributed among a plurality of such functional elements. The one or more processors 614 can be functionally coupled a memory 644 and to at least on (e.g., one, two, more than two, or each) functional element within the device 610 via bus 637. In certain implementations, the bus 637 can be embodied in or can comprise one or more of a memory bus, a system bus, an address bus, a message bus, a power bus, or one or more reference links or interface(s).

In one aspect, the memory 644 can contain one or more memory elements 646 having computer-accessible instructions encoded thereon. The one or more memory elements 646 are referred to as functionality instructions storage 646, which can comprise one or more health management component(s) 647. In one aspect, in response to execution of at least one of the health management component(s) 516, the mobile device can provide the health management functionality described in the present disclosure. In certain implementations, the functionality instructions(s) storage 646 can be embodied in a removable element, such as a subscriber identification module (SIM) card storage, a universal integrated circuit card (UICC) storage, or a removable user identity module (RUIM). In another aspect, the memory 644 can comprise functionality information storage 648, which can include information specific to sensing or otherwise collecting physiological information 144 and/or situational information 148, and/or supplying a response or a protocol for healthcare or plan for healthcare management in accordance with aspects of the disclosure. Such information can be retained or otherwise stored in a memory element 649 (labeled health management information 649).

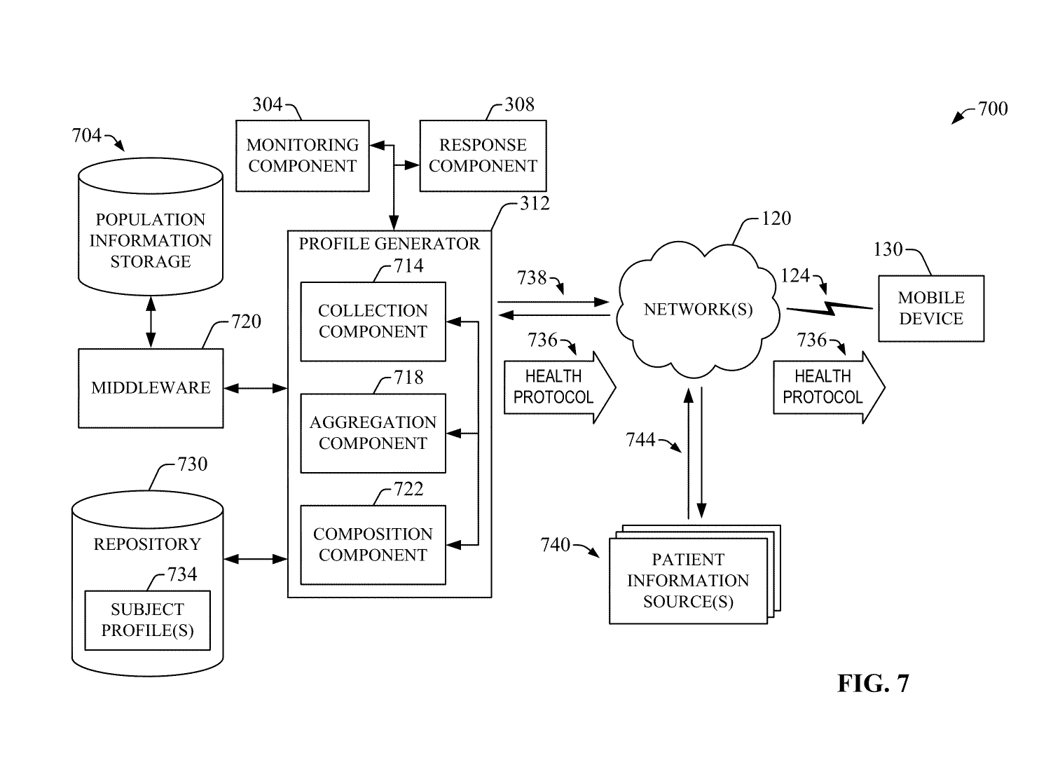

FIG. 7 illustrates a block diagram example embodiment of an operation environment for mobile healthcare management in accordance with one or more aspects of the disclosure. As illustrated, such operational environment comprises the monitoring component 304, the response component 308, and the profile generator 312. In certain implementations, as described herein, such functional elements can embody or can constitute the health management unit 250. In one aspect, the profile generator 312 can comprise a collection component 714 that can acquire, for example, medical information for a population of subjects from a plurality of sources (e.g., sources 114). The plurality of sources can be represented as a population information storage 704, which can be or can comprise a distributed network repository (e.g., a collection of several storage devices or platforms, such as distributed cloud storage). In the illustrated embodiment, the profile generator can be functionally coupled to a middleware 720. In one aspect, the middleware 720 can include one or more computing platforms (e.g., gateways, routers, switches, boundary servers, combination thereof, or the like) for exchange of information (e.g., data, metadata, and/or signaling) between a source of information in the population information storage 704 and at least the profile generator 312. In one implementation, the collection component 714 can include an input layer (e.g., a localized or distributed computing platform deployed as a single logical unit) that can receive medical information from an electronic medical record (EMR) platform via a dedicated component in the middleware 720, and/or from Health Information Exchange (HIX) that can obtain medical information (e.g., medical record data) from disparate EMR platforms.

In addition, the collection component 714 can acquire physiological information (e.g., at least a portion of the physiological information 114) and/or situational information (e.g., at least a portion of the situational information 118) from the mobile device 130. In one aspect, the collection component 714 can format at least a portion of the information that is acquired from the population information storage 704 or the mobile device 130 into a format suitable for generation of a reference patient profile.

In addition, the profile generator 312 comprises an aggregation component 718 that can analyze or otherwise process information that is acquired from the population information storage 704 or from the mobile device 130. At least a portion of the information that is acquired from the population information storage 704 and one or more of the physiological information or the situational information can be collectively referred to as medical information. In addition, other medical information can be received form at least one of one or more patient information sources 740. For instance, in one implementation, the profile generator 312 can acquire the other medical information from a remote device associated with a healthcare provider associated with the specific subject. In certain embodiments, the collection component 714 can acquire medical information for a population of subjects from at least two of a source of longitudinal clinical records, a source of pharmaceutical records, a source of evidence-based clinical information, or a source of infrastructure records.

The profile generator 312 can include a composition component 722 that can generate a reference subject profile for a specific subject of a population of subjects based at least on the portion of the medical information that is analyzed or otherwise processed at the profile generator 312, via the aggregation component 718, for example. In certain implementations, the composition component 722 can generate or can update a reference subject profile in response the profile generator 312 collecting, via the collection component 714, for example, current or otherwise updated medical information at the population information storage 704. In addition or in the alternative, as described herein, the composition component 722 can generate a current patient profile for the specific subject based at least on medical information associated therewith. For instance, in one embodiment, the composition component 722 can generate the current patient profile in response to the profile generator 312 receiving current physiological information and/or current situational information. In certain embodiments, the composition component 722 can generate and categorize (e.g., customize) a reference subject profile according to information (e.g., medical information, financial information, etc.) associated with a subject and received from a medical provider of the subject.

The composition component 722 can retain a reference subject profile and/or a current subject profile into one or more memory elements 734 (labeled subject profile(s) 734) within a repository 730. In one aspect, the repository 730 can comprise the repository 260 and the subject profile(s) 734 can comprise the reference patient profile 264 and the current patient profile(s) 268.

In one aspect, the reference subject profile can comprise one or more of a metric indicative of a health condition of the specific subject; a protocol for episodic care or a plan for healthcare management; a criterion for satisfactory episodic care or a criterion for satisfactory healthcare management; or a criterion for presence of a medical emergency. As described herein, the medical emergency can comprise, for example, acute cardiac arrest, acute renal failure, hypoglycemic coma, a combination thereof, or the like.

In one aspect, the profile generator 312 can supply (e.g., transmit or generate and transmit) or otherwise communicate a health protocol 736 to a remote device (e.g. the mobile device 130) that associated with a specific subject. The health protocol 736 can be specific or otherwise customized to the specific subject associated with the remote device. In one aspect, the composition component 722 can generate the health protocol 736 based at least in part on medical information that is aggregated at the profile generator 312, via the aggregation component 718, for example. In addition or in the alternative, the composition component 722 can generate the health protocol 736 based at least on medical information received from at least one of the patient information sources 740 (e.g., a physician, a nurse, a hospital platform, a health insurance carrier, a combination thereof, or the like). As described herein, the health protocol 736 can comprise a protocol for episodic care, a plan for healthcare management, or the like.

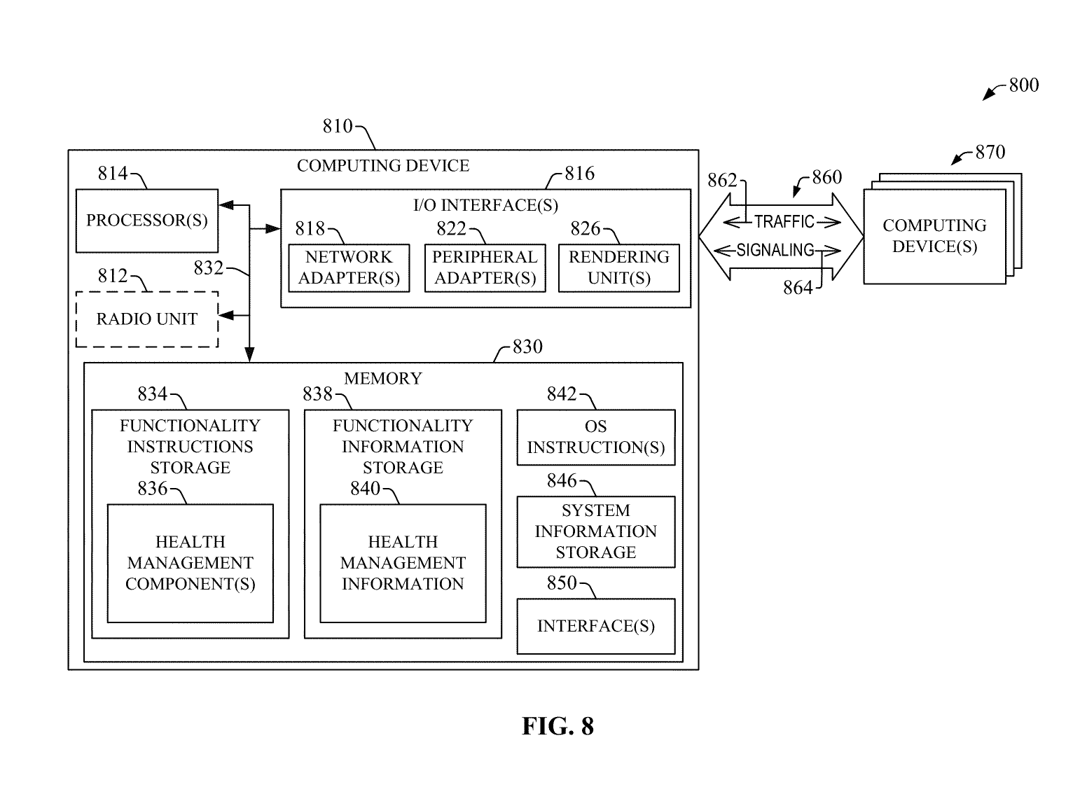

FIG. 8 illustrates a block diagram of an example operational environment for mobile health management in accordance with one or more aspects of the disclosure. These example operational environments are only illustrative and are not intended to suggest or otherwise convey any limitation as to the scope of use or functionality of the operating environments' architecture. In addition, the operational environments should not be interpreted as having any dependency or requirement relating to any one or combination of components illustrated in these example operational environments. These operational environments can embody or can comprise the health management unit 250 and/or the health management unit 250 and the mobile device 130.

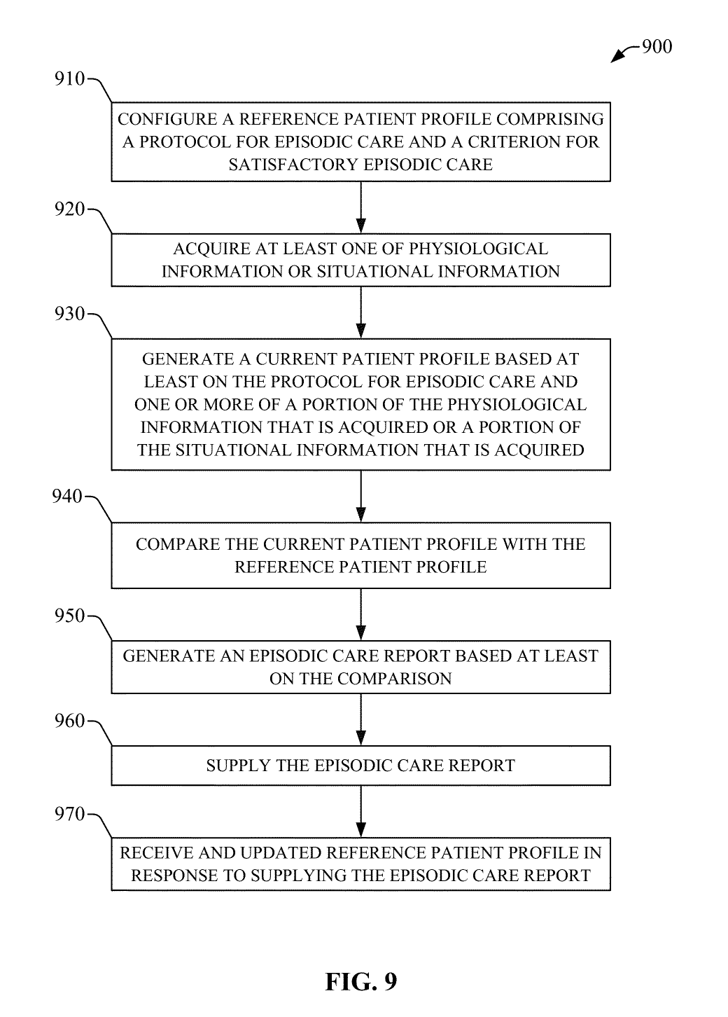

The operational environment 800 represents an example software implementation of the various aspects or features of the disclosure in which the processing or execution of operations described in connection with the disclosed mobile healthcare management disclosed herein can be performed in response to execution of one or more software components at the computing device 810. It should be appreciated that the one or more software components can render the computing device 810, or any other computing device that contains such components, a particular machine for mobile healthcare management as described herein, among other functional purposes. A software component can be embodied in or can comprise one or more computer-accessible instructions, e.g., computer-readable and/or computer-executable instructions. In one scenario, at least a portion of the computer-accessible instructions can embody at least a part of one or more of the example methods presented in FIGS. 9-11. For instance, to embody one such method, at least the portion of the computer-accessible instructions can be persisted (e.g., stored, made available, or stored and made available) in a computer storage non-transitory medium and executed by a processor. The one or more computer-accessible instructions that embody a software component can assembled into one or more program modules, for example, that can be compiled, linked, and/or executed at the computing device 810 or other computing devices. Generally, such program modules comprise computer code, routines, programs, objects, components, information structures (e.g., data structures and/or metadata structures), etc., that can perform particular tasks (e.g., one or more operations) in response to execution by one or more processors, which can be integrated into the computing device 810 or functionally coupled thereto.

The various example embodiments of the disclosure can be operational with numerous other general purpose or special purpose computing system environments or configurations. Examples of well-known computing systems, environments, and/or configurations that can be suitable for implementation of various aspects or features of the disclosure in connection with the mobile healthcare management described herein can comprise personal computers; server computers; laptop devices; handheld computing devices, such as mobile tablets; wearable computing devices; and multiprocessor systems. Additional examples can include set-top boxes, programmable consumer electronics, network PCs, minicomputers, mainframe computers, blade computers, programmable logic controllers, distributed computing environments that comprise any of the above systems or devices, and the like.

As illustrated, the computing device 810 can comprise one or more processors 814, one or more input/output (I/O) interfaces 816, a memory 830, and a bus architecture 832 (also termed bus 832) that functionally couples various functional elements of the computing device 810. In certain embodiments, the computing device 810 can include, optionally, a radio unit 812. The radio unit 812 can have substantially the same architecture and functionality as that of the radio unit 636 described herein. The bus 832 can include at least one of a system bus, a memory bus, an address bus, or a message bus, and can permit exchange of information (data, metadata, and/or signaling) between the processor(s) 814, the I/O interface(s) 816, and/or the memory 830, or respective functional element therein. In certain scenarios, the bus 832 in conjunction with one or more internal programming interfaces 850 (also referred to as interface(s) 850) can permit such exchange of information. In scenarios in which processor(s) 814 include multiple processors, the computing device 810 can utilize parallel computing.

The I/O interface(s) 816 permit communication of information between the computing device and an external device, such as another computing device, e.g., a network element or an end-user device. Such communication can include direct communication or indirect communication, such as exchange of information between the computing device 810 and the external device via a network or elements thereof. As illustrated, the I/O interface(s) 816 can comprise one or more of network adapter(s) 818, peripheral adapter(s) 822, and rendering unit(s) 826. Such adapter(s) can permit or facilitate connectivity between the external device and one or more of the processor(s) 814 or the memory 830. For example, the peripheral adapter(s) 822 can include a group of ports, which can comprises at least one of parallel ports, serial ports, Ethernet ports, V.35 ports, or X.21 ports, wherein parallel ports can comprise General Purpose Interface Bus (GPIB), IEEE-1284, while serial ports can include Recommended Standard (RS)-232, V.11, Universal Serial Bus (USB), FireWire or IEEE-1394.

In one aspect, at least one of the network adapter(s) 818 can couple functionally the computing device 810 to one or more computing devices 870 via one or more traffic and signaling pipes 860 that can permit or facilitate exchange of traffic 862 and signaling 864 between the computing device 810 and the one or more computing devices 870. Such network coupling provided at least in part by the at least one of the network adapter(s) 818 can be implemented in a wired environment, a wireless environment, or both. The information that is communicated by the at least one of the network adapter(s) 818 can result from implementation of one or more operations in a method of the disclosure. Such output can be any form of visual representation, including, but not limited to, textual, graphical, animation, audio, tactile, and the like. In certain scenarios, each of the computing device(s) 870 can have substantially the same architecture as the computing device 810. In addition or in the alternative, the rendering unit(s) 826 can include functional elements (e.g., lights, such as light-emitting diodes; a display, such as liquid crystal display (LCD), a plasma monitor, a light emitting diode (LED) monitor, an electrochromic monitor; combinations thereof; or the like) that can permit control of the operation of the computing device 810, or can permit conveying or revealing the operational conditions of the computing device 810.

In one aspect, the bus 832 represents one or more of several possible types of bus structures, including a memory bus or memory controller, a peripheral bus, an accelerated graphics port, and a processor or local bus using any of a variety of bus architectures. As an illustration, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI) bus, a PCI-Express bus, a Personal Computer Memory Card Industry Association (PCMCIA) bus, a Universal Serial Bus (USB) and the like. The bus 832, and all buses described herein can be implemented over a wired or wireless network connection and each of the subsystems, including the processor(s) 814, the memory 830 and memory elements therein, and the I/O interface(s) 816 can be contained within one or more remote computing devices 870 at physically separate locations, connected through buses of this form, in effect implementing a fully distributed system.

The computing device 810 can comprise a variety of computer-readable media. Computer-readable media can be any available media (transitory and non-transitory) that can be accessed by a computing device. In one aspect, computer-readable media can comprise computer non-transitory storage media (or computer-readable non-transitory storage media) and communications media. Example computer-readable non-transitory storage media can be any available media that can be accessed by the computing device 810, and can comprise, for example, both volatile and non-volatile media, and removable and/or non-removable media. In one aspect, the memory 830 can comprise computer-readable media in the form of volatile memory, such as random access memory (RAM), and/or non-volatile memory, such as read-only memory (ROM).

The memory 830 can comprise functionality instructions storage 834 and functionality information storage 838. The functionality instructions storage 834 can comprise computer-accessible instructions that, in response to execution (by at least one of the processor(s) 814), can implement one or more of the functionalities of the disclosure. The computer-accessible instructions can embody or can comprise one or more software components illustrated as profile generation component(s) 836. In one scenario, execution of at least one component of the profile generation component(s) 836 can implement one or more of the example methods 1000 through 1100. For instance, such execution can cause a processor that executes the at least one component to carry out a disclosed example method. It should be appreciated that, in one aspect, a processor of the processor(s) 814 that executes at least one of the profile generation component(s) 836 can retrieve information from or retain information in a memory element 840 in the functionality information storage 838 in order to operate in accordance with the functionality programmed or otherwise configured by the profile generation component(s) 836. Such information can include at least one of code instructions, information structures, or the like. At least one of the one or more interfaces 850 (e.g., application programming interface(s)) can permit or facilitate communication of information between two or more components within the functionality instructions storage 834. The information that is communicated by the at least one interface can result from implementation of one or more operations in a method of the disclosure. In certain embodiments, one or more of the functionality instructions storage 834 and the functionality information storage 838 can be embodied in or can comprise removable/non-removable, and/or volatile/non-volatile computer storage media.

At least a portion of at least one of the profile generation component(s) 836 or profile generation information 840 can program or otherwise configure one or more of the processors 814 to operate at least in accordance with the functionality described herein. In one embodiment, the profile generation component(s) 836 contained in the functionality instruction(s) storage 834 can include the exchange component 318, the presence analysis component 320, the location generator 330, the ID configuration component 340, and (in certain embodiments or optionally) the learning component 410. It should be recognized that in such embodiment, hardware or firmware functional elements of the exchange component 318 can be embodied in suitable components of the computing device 810. For instance, at least one of the processors 814 and at least one of the I/O interface(s) 816 (e.g., a network adapter of the network adapter(s) 818) can embody a communication unit of the exchange component 318. In addition, in embodiment 880, the functionality information storage 838 can comprise the mapping(s) 354. One or more of the processor(s) 814 can execute at least one of such components and leverage at least a portion of the information in the functionality information storage 838 in order to provide mobile healthcare management in accordance with one or more aspects described herein.

It should be appreciated that, in certain scenarios, the functionality instruction(s) storage 834 can embody or can comprise a computer-readable non-transitory storage medium having computer-accessible instructions that, in response to execution, cause at least one processor (e.g., one or more of processor(s) 814) to perform a group of operations comprising the operations or blocks described in connection with the disclosed methods.

In addition, the memory 830 can comprise computer-accessible instructions and information (e.g., data and/or metadata) that permit or facilitate operation and/or administration (e.g., upgrades, software installation, any other configuration, or the like) of the computing device 810. Accordingly, as illustrated, the memory 830 can comprise a memory element 842 (labeled operating system (OS) instruction(s) 842) that contains one or more program modules that embody or include one or more operating systems, such as Windows operating system, Unix, Linux, Symbian, Android, Chromium, and substantially any OS suitable for mobile computing devices or tethered computing devices. In one aspect, the operational and/or architecture complexity of the computing device 810 can dictate a suitable OS. The memory 830 also comprises a system information storage 846 having data and/or metadata that permits or facilitate operation and/or administration of the computing device 810. Elements of the OS instruction(s) 842 and the system information storage 846 can be accessible or can be operated on by at least one of the processor(s) 814.

It should be recognized that while the functionality instructions storage 834 and other executable program components, such as the OS instruction(s) 842, are illustrated herein as discrete blocks, such software components can reside at various times in different memory components of the computing device 810, and can be executed by at least one of the processor(s) 814. In certain scenarios, an implementation of the profile generation component(s) 836 can be retained on or transmitted across some form of computer-readable media.

The computing device 810 and/or one of the computing device(s) 870 can include a power supply (not shown), which can power up components or functional elements within such devices. The power supply can be a rechargeable power supply, e.g., a rechargeable battery, and it can include one or more transformers to achieve a power level suitable for operation of the computing device 810 and/or one of the computing device(s) 870, and components, functional elements, and related circuitry therein. In certain scenarios, the power supply can be attached to a conventional power grid to recharge and ensure that such devices can be operational. In one aspect, the power supply can include an I/O interface (e.g., one of the network adapter(s) 818) to connect operationally to the conventional power grid. In another aspect, the power supply can include an energy conversion component, such as a solar panel, to provide additional or alternative power resources or autonomy for the computing device 810 and/or one of the computing device(s) 870.

The computing device 810 can operate in a networked environment by utilizing connections to one or more remote computing devices 870. As an illustration, a remote computing device can be a personal computer, a portable computer, a server, a router, a network computer, a peer device or other common network node, and so on. As described herein, connections (physical and/or logical) between the computing device 810 and a computing device of the one or more remote computing devices 870 can be made via one or more traffic and signaling pipes 860, which can comprise wireline link(s) and/or wireless link(s) and several network elements (such as routers or switches, concentrators, servers, and the like) that form a local area network (LAN) and/or a wide area network (WAN). Such networking environments are conventional and commonplace in dwellings, offices, enterprise-wide computer networks, intranets, local area networks, and wide area networks.

In one or more embodiments, one or more of the disclosed methods can be practiced in distributed computing environments, such as grid-based environments, where tasks can be performed by remote processing devices (computing device(s) 870) that are functionally coupled (e.g., communicatively linked or otherwise coupled) through a network having traffic and signaling pipes and related network elements. In a distributed computing environment, in one aspect, one or more software components (such as program modules) can be located in both a local computing device 810 and at least one remote computing device.

In view of the aspects described herein, example methods that can be implemented in accordance with the disclosure can be better appreciated with reference to the flowcharts in FIGS. 9-11. For purposes of simplicity of explanation, the example methods disclosed herein are presented and described as a series of blocks (with each block representing an action or an operation in a method, for example). However, it is to be understood and appreciated that the disclosed methods are not limited by the order of blocks and associated actions or operations, as some blocks may occur in different orders and/or concurrently with other blocks from that are shown and described herein. For example, the various methods or processes of the disclosure can be alternatively represented as a series of interrelated states or events, such as in a state diagram. Furthermore, not all illustrated blocks, and associated action(s), may be required to implement a method in accordance with one or more aspects of the disclosure. Further yet, two or more of the disclosed methods or processes can be implemented in combination with each other, to accomplish one or more features or advantages described herein.

It should be appreciated that the methods of the disclosure can be retained on an article of manufacture, or computer-readable medium, to permit or facilitate transporting and transferring such methods to a computing device for execution, and thus implementation, by a processor of the computing device or for storage in a memory thereof or functionally coupled thereto. The computing device can be embodied in or can comprise a desktop computer; a mobile computer, such as a tablet, or a smartphone; a gaming console; a mobile telephone; a wearable computing device; a blade computer; a programmable logic controller; and the like. In one aspect, one or more processors, such as processor(s) that implement (e.g., execute) one or more of the disclosed methods, can be employed to execute code instructions retained in a memory, or any computer- or machine-readable medium, to implement the one or more methods. The code instructions can provide a computer-executable or machine-executable framework to implement the methods described herein.

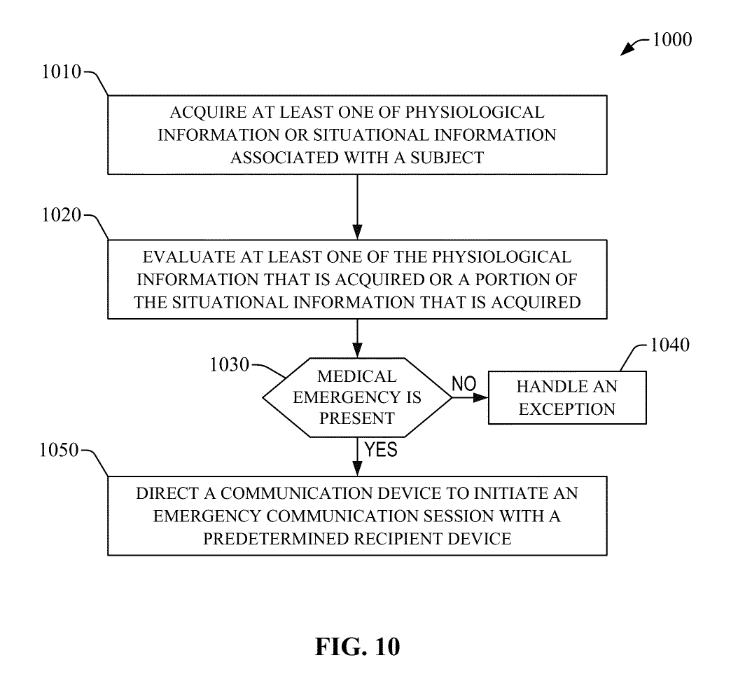

FIGS. 9-10 illustrate flowcharts of example methods 900 and 1000, respectively, for mobile health management according to at least certain aspects of the disclosure. One or more computing devices (either mobile or pseudo-stationary) having at least one processor or being functionally coupled to at least one processor can implement (e.g., compile, execute, compile and execute, etc.) one or more blocks of the subject example methods 900 and 1000. As an illustration, the health management unit 250 can implement the example methods 900 and 1000. In other scenarios, one or more blocks of the example methods 900 and 1000 can be implemented in a distributed fashion (e.g., in a cloud solution or implementation) by two or more computing devices contained in an operational environment, such as a system or platform. Each of the two or more computing devices can have at least one processor or can be functionally coupled to at least one processor, where such processor(s) can implement at least one of the one or more blocks in the example methods 900 and 1000.

Example method 900 is directed to interactive mobile episodic care management according to one or more aspects of the disclosure. It should be appreciated that while the example method 900 refers to episodic care management, such method is not so limited and such references are for the sake of illustration. The example method 900 also can be implemented for substantially any healthcare protocol.

At block 910, a reference patient profile comprising a protocol for episodic care and a criterion for satisfactory episodic care of a patient is configured. As described herein, the reference patient profile can be customized to a specific patient. At block 920, at least one of physiological information indicative of health condition of the patient or situational information indicative of behavior of the patient can be acquired. Such information can be acquired in accordance with the protocol for episodic care via one or more sensing devices (e.g., a camera, a microphone, an accelerometer, a gyroscope, a glucometer, a blood pressure monitor, a blood testing device, a combination thereof, or the like). At block 930, a current patient profile is generated based at least on the protocol for episodic care and one or more of a portion of the physiological information that is acquired or a portion of the situational information that is acquired. At block 940, the current patient profile is compared with the reference patient profile. As described herein, other forms of evaluation, such as generation of trends and prediction of patient behavior, also can be implemented with respect to the reference patient profile. Block 940 can be referred to as a comparing operation and, in one aspect, can comprise determining if the criterion for satisfactory episodic care is satisfied. At block 950, an episodic care report comprising information indicative of an outcome of the comparing operation. In one aspect, the outcome of the comparing comprises an indication that the criterion for satisfactory episodic care is satisfied or an indication that the episodic care is not satisfied.

At block 960, the episodic care report can be supplied (e.g., transmitted) to a predetermined recipient device. In certain implementations, the episodic care report can be transmitted to a remote computing device associated with a care provider (e.g., a physician, a nurse, or a podiatrist) for the patient. At block 960, an updated protocol for episodic care can be received in response to supplying the episodic care report. For example, in certain embodiments, the care provider (e.g., a physician or a nurse) can adjust dosage or type of a medication that is administered to the patient as part of the protocol for episodic care.

As described herein, health management or health monitoring of a subject can produce a response that can be supplied to predetermined first responders and/or other recipients associated with the subject (e.g., subject 140). Such recipients can include medical care providers or healthcare payors, which can be responsible for reimbursement of healthcare costs related to the subject. Example method 1000 is directed to supplying an alert in response to a medical emergency associated with the subject as part of the health management or health monitoring. At block 1010, at least one of physiological information or situational information associated with a subject can be acquired. In certain implementations, the physiological information and/or the situational information can be acquired in response to an event associated with the patient. In one implementation, the computing device or a processor that implements the subject example method can direct a sensing device to collect at least a portion of the physiological information and/or the situational information. The computing device or the processor that implements the subject example method can receive the information that is acquired from the sensing device.

At block 1020, at least one of a portion of the physiological information that is acquired or a portion of the situational information that is acquired can be evaluated. Block 1020 can referred to as an evaluating operation. At block 1030, it is determined if a medical emergency associated with the subject is present. In one embodiment, presence of the medical emergency can be determined by comparing an outcome of the evaluating operation with a criterion for presence of a medical emergency condition of the subject. As an illustration, as described herein, the medical emergency can be or can include an acute cardiac arrest, an acute renal failure episode, or an acute asthma attack. In response to ascertaining that the medical emergency condition is not present, an exception can be handled at block 1040. For example, the computing device that implements the subject example method 1000 can submit, to a communication device associated with the subject (e.g., mobile device 130) a machine-executable instruction or command to render indicia indicative of absence of an emergency situation. In addition, the computing device can submit, to such communication device, another machine-executable instruction or command to render information indicative of a likely palliative for the current health condition or situation of the subject. In contrast, in response to ascertaining that the medical emergency condition is present, an emergency communication session with a predetermined recipient device can be initiated or established by the communication device associated with the subject. To at least such end, at block 1050, the communication device can be directed to initiate the emergency communication session—e.g., the communication device can receive, from the computing device, a machine-executable instruction to initiate or otherwise establish the emergency communication session. For example, in one embodiment, a voice call to 911 can be initiated or established. In one aspect, the voice call can convey at least information indicative of the medical emergency condition and/or location (e.g., latitude and longitude, postal address, or the like) of the subject. For another example, in another embodiment, a non-voice communication session with a predetermined recipient device can be initiated or established. In one aspect, the communication session can convey at least information indicative of the medical emergency condition and location of the patient. It should be appreciated that in certain scenarios, the emergency communication session can comprise a voice call (to 911 or other emergency contact) and a non-voice call (a SMS communication or a MMS communication).

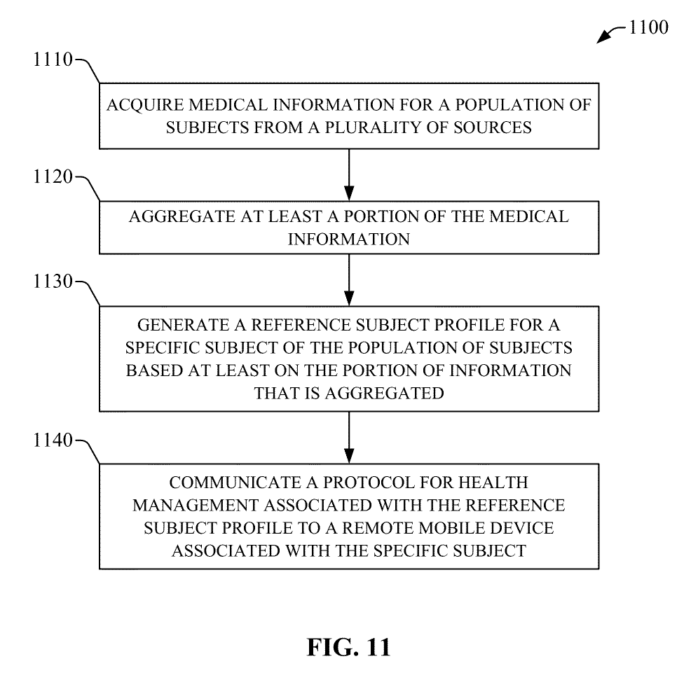

As described herein, a reference subject profile or reference patient profile can be generated at a network node or network computing platform. FIG. 11 illustrates a flowchart of an example method 1100 for composing a reference subject profile according to one or more aspects of the disclosure. One or more computing devices (either mobile or pseudo-stationary) that are contained in the network node or network computing platform can implement (e.g., compile, execute, compile and execute, etc.) one or more blocks of the subject example method 1100. Each of the one or more computing devices can have at least one processor or being functionally coupled to at least one processor. As an illustration, the computing device 810, which can embody the profile generator 710, for example, can implement the example method 1100. In other scenarios, one or more blocks of the example methods 900 and 1000 can be implemented in a distributed fashion (e.g., in a cloud solution or implementation) by two or more computing devices contained in an operational environment, such as a system or platform. Each of the two or more computing devices can have at least one processor or can be functionally coupled to at least one processor, where such processor(s) can implement at least one of the one or more blocks in the example methods 900 and 1000.

At block 1110 medical information for a population of subjects is acquired from a plurality of sources. As described herein, in certain embodiments, the plurality of source can include at least two of a source of longitudinal clinical records, a source of pharmaceutical information, a source of evidence-based clinical information, or a source of infrastructure information. At block 1120, at least a portion of the medical information can be aggregated. At block 1130, a reference subject profile can be generated for a specific subject of the population of subjects based at least on the portion of the medical information that is aggregated. Block 1130 can be referred to as a generating operation. As described herein, in certain embodiments, the reference subject profile can comprise one or more of a metric indicative of a health condition of the specific subject; a protocol for episodic care or a health management plan; a criterion for satisfactory episodic care; or a criterion for presence of a medical emergency (e.g., physiological acute medical emergencies).

In certain embodiments, as described herein, the generating operation can include acquiring second medical information from a remote device associated with a healthcare provider (e.g., a physician, a nurse, a podiatrist, a personal trainer, or the like) associated with the specific subject (e.g., subject 140). In addition, the reference subject profile can be updated based at least on a portion of the second medical information. At block 1140, a protocol for healthcare management associated with the reference subject profile can be communicated (e.g., transmitted) to a remote mobile device (e.g., mobile device 130) associated with the specific subject.

Various illustrative embodiments of the disclosure emerge from the specification herein and the annexed drawings. In one example embodiment, the disclosure provides a computing device (or device), such as computing device 810. The device can comprise at least one memory having computer-executable instructions encoded thereon; and at least one processor functionally coupled to the at least one memory and configured, by computer-executable instructions, to configure a reference patient profile comprising a protocol for episodic care and a criterion for satisfactory episodic care of a patient; to acquire at least one of physiological information indicative of health condition of the patient or situational information indicative of behavior of the patient; to generate a current patient profile based at least on the protocol for episodic care and one or more of a portion of the physiological information that is acquired or a portion of the situational information that is acquired; to compare the current patient profile with the reference patient profile; to generate an episodic care report comprising information indicative of an outcome of the comparison. In one aspect, the outcome of the comparison can comprise an indication (e.g., an information asset) that the criterion for satisfactory episodic care is satisfied or an indication that the criterion for satisfactory episodic care is not satisfied.

In one aspect, the at least one processor can be further configured to transmit the episodic care report to a remote computing device associated with a care provider for the patient. In another aspect, the at least one processor can be further configured to receive an updated protocol for episodic care in response to the supplying. In yet another aspect, the at least one processor can be further configured to transmit a request for a prescription associated with the protocol for episodic care. In still another aspect, the at least one processor is further configured to update an extant patient profile based at least on one or more of the portion of the portion of the physiological information that is collected or the portion of the situational information that is collected. In an addition or alternative aspect, the at least one processor can be further configured to acquire at least one of second physiological information or second situational information in response to an event associated with the patient. In still another aspect, the at least one processor can be further configured to evaluate at least one of a portion of the second physiological information that is acquired or a portion of the second situational information that is acquired.

In another aspect, the at least one processor can be further configured to compare an outcome of the evaluating with a second criterion for presence of a medical emergency condition of the patient. In yet another aspect, the at least one processor can be further configured to transmit, to a mobile device associated with the patient, a command (e.g., a computer-executable instruction) to initiate an emergency communication session with a predetermined recipient device in response to an outcome of the comparison indicating presence of the medical emergency condition. In another aspect, the at least one processor can be further configured to transmit, to the mobile device associated with the patient, a command to initiate a voice call to 911 in response to an outcome of the comparing indicating presence of the medical emergency condition, the voice call conveying at least information indicative of the medical emergency condition. In another aspect, the at least one processor can be further configured to transmit, to the mobile device associated with the patient, a command to initiate a non-voice communication session with predetermined recipient device, the communication session conveying at least information indicative of the medical emergency condition and location of the patient.

In other illustrative embodiment, the disclosure can provide a mobile device (e.g., mobile device 130) where the mobile device can comprise a plurality of sensing devices configured to acquire at least one of physiological information indicative of health condition of a subject or situational information indicative of behavior of the subject; a communication unit configured to receive medical information wirelessly from a remote computing device, the medical information comprising a protocol for health management and a criterion for satisfactory health management; and a health management client unit functionally coupled to the communication unit and at least one of the plurality of sensing devices and configured to control acquisition of one or more of a portion of the physiological information or a portion of the situational information based at least on the protocol for health management, and to generate a health management response based at least on the protocol for health management and one or more of the portion of the physiological information that is acquired or the portion of the situational information that is acquired.

In one aspect, the communication unit can be further configured to transmit the health management response wirelessly to a remote computing device associated with a care provider for the subject. In another aspect, the communication unit can be further configured to receive an updated protocol for health management in response to the transmission. In still another aspect, the communication unit can be further configured to render at least a portion of the protocol for health management. In another aspect, the communication unit can be further configured to transmit wirelessly a request for a product associated with the protocol for health management, and wherein the product comprises one or more of a medication, a food supplement, a medical device, or an exercise machine. In yet another aspect, the communication unit is further configured to render at least a portion of the protocol for health management. In another aspect, the communication unit can be further configured to render indicia indicative of a scheduled intake of a medication. In yet another aspect, the communication unit can be further configured to render indicia indicative of a scheduled exercise activity.

In one aspect, the health management unit can be further configured to receive information indicative of physical activity from at least one of the plurality of sensing devices. In another aspect, the health management unit can be further configured to receive information indicative of caloric expenditure.

In one aspect, at least one of plurality of the sensing devices can be configured to acquire information indicative of one or more of type of a foodstuff, a caloric content of the foodstuff, a carbohydrate content of the foodstuff, a fiber content of the foodstuff, nuts content of the foodstuff. The information can be conveyed by or otherwise contained in a barcode or a quick response code (QRC). It should be appreciated that substantially any other code conveying such information can be contemplated in the disclosure. In another aspect, the health management unit can be further configured to receive test information from an external sensing device that collects a blood sample of the subject, and can be further configured to analyze the test information according to the reference health profile. In another aspect, the health management unit is further configured to generate at least one biometric based at least on the analysis.

In one aspect, at least one of the plurality of sensing devices is further configured to acquire at least one of second physiological information or second situational information in response to an event associated with the patient. In another aspect, the health management unit is further configured to transmit, to a network platform, at least one of a portion of the second physiological information that is acquired or a portion of the second situational information that is acquired. In yet another aspect, the health management unit can be further configured to receive a command to an emergency communication session with a predetermined recipient device in response to presence of the medical emergency condition. In yet another aspect, the health management unit is further configured to initiate the emergency communication session with the predetermined recipient device in response to the command that is received. In still another aspect, the emergency communication session comprises one or more of a voice call to 911 configured to convey at least information indicative of the medical emergency condition, or a non-voice communication session configured to convey at least information indicative of the medical emergency condition and location of the patient.

In another example embodiment, the disclosure provides a method that can comprise configuring, at a computing device, a reference patient profile comprising a protocol for episodic care and a criterion for satisfactory episodic care of a patient. The method also can comprise acquiring, at the computing device and according to the protocol for episodic care, at least one of physiological information indicative of health condition of the patient or situational information indicative of behavior of the patient. The method can further comprise generating, at the computing device, a current patient profile based at least on the protocol for episodic care and one or more of a portion of the physiological information that is acquired or a portion of the situational information that is acquired. In addition, the method can comprise comparing, at the computing device, the current patient profile with the reference patient profile. The method also can comprise generating, at the computing device, an episodic care report comprising information indicative of an outcome of the comparing, wherein the outcome of the comparing comprises an indication that the criterion for satisfactory episodic care is satisfied or an indication that the episodic care is not satisfied.

In one aspect, the method can further comprise transmitting, by the computing device, the episodic care report to a remote computing device associated with a care provider for the patient. In another aspect, the method can further comprise receiving, at the computing device, an updated protocol for episodic care in response to the supplying. In another aspect, the method can further comprise transmitting a request for a prescription associated with the protocol for episodic care. In one aspect, the generating can comprise updating an extant patient profile based at least on one or more of the portion of the portion of the physiological information that is acquired or the portion of the situational information that is acquired. In another aspect, when the acquiring includes the situational information, the acquiring can comprise receiving information indicative of physical activity. In still another aspect, when the acquiring includes the situational information, the acquiring can comprise receiving information indicative of caloric expenditure. In yet another aspect, when the acquiring includes the situational information, the acquiring can comprise acquiring information indicative of one or more of type of a foodstuff, a caloric content of the foodstuff, a carbohydrate content of the foodstuff, a fiber content of the foodstuff, nuts content of the foodstuff In still another aspect, the method can further comprise acquiring, at the computing device, at least one of second physiological information or second situational information in response to an event associated with the patient.

In one aspect, the method can further comprise evaluating, at the computing device, at least one of a portion of the second physiological information that is acquired or a portion of the second situational information that is acquired. In another aspect, the method can further comprise comparing, at the computing device, an outcome of the evaluating with a second criterion for presence of a medical emergency condition of the patient. In another aspect, the method can further comprising initiating, at the computing device, an emergency communication session with a predetermined recipient device in response to an outcome of the comparing indicating presence of the medical emergency condition. In yet another aspect, the method can further comprise initiating, at the computing device, a voice call to 911 in response to an outcome of the comparing indicating presence of the medical emergency condition, the call conveying at least information indicative of the medical emergency condition. In still another aspect, the method can comprise initiating, at the computing device, a non-voice communication session with predetermined recipient device, the communication session conveying at least information indicative of the medical emergency condition and location of the patient.

In still another example embodiment, the disclosure can provide another method comprising acquiring, at a computing platform comprising at least one processor, medical information for a population of subjects from a plurality of sources; aggregating, at the computing platform, at least a portion of the medical information; and generating, at the computing platform, a reference subject profile for a specific subject of the population of subjects based at least on the portion of the medical information that is aggregated. In one aspect, the reference subject profile can comprise one or more of a metric indicative of a health condition of the specific subject, a protocol for episodic care, a criterion for satisfactory episodic care, or a criterion for presence of a medical emergency. In one aspect, such another method can further comprise communicating the protocol for episodic care to a remote device associated with the specific subject. In still another aspect, the acquiring comprises acquiring the medical information for the population of subjects from at least two of a source of longitudinal clinical records, a source of pharmaceutical records, a source of evidence-based clinical information, or a source of infrastructure records.

In another aspect, such another method can comprise acquiring, at the computing platform, second medical information from a remote device associated with a healthcare provider associated with the specific subject. In yet another aspect, such method can comprise updating the reference subject profile based at least on a portion of the second medical information.

In a further or alternative embodiment, the disclosure provides an apparatus, such as health management unit. The apparatus can comprise at least one memory having computer-executable instructions encoded thereon; and at least one processor functionally coupled to the at least one memory and configured, by computer-executable instructions, acquire medical information for a population of subjects from a plurality of sources; aggregate (e.g., extract patterns, determine trends, consolidate information) or otherwise process at least a portion of the medical information; and generate a reference subject profile for a specific subject of the population of subjects based at least on the portion of the medical information that is aggregated. In one aspect, the reference subject profile can comprise one or more of a metric indicative of a health condition of the specific subject, a protocol for episodic care, a criterion for satisfactory episodic care, or a criterion for presence of a medical emergency.

In another aspect, the at least one processor can be further configured to communicate the protocol for episodic care to a remote device associated with the specific subject. In another aspect, the at least one processor can be further configured to acquire the medical information for the population of subjects from at least two of a source of longitudinal clinical records, a source of pharmaceutical records, a source of evidence-based clinical information, or a source of infrastructure records. In still another aspect, the at least one processor is further configured to acquire second medical information from a remote device associated with a healthcare provider associated with the specific subject. In yet another aspect, the at least one processor is further configured to update the reference subject profile based at least on a portion of the second medical information.

Various embodiments of the disclosure may take the form of an entirely or partially hardware embodiment, an entirely or partially software embodiment, or a combination of software and hardware (e.g., a firmware embodiment). Furthermore, as described herein, various embodiments of the disclosure (e.g., methods and systems) may take the form of a computer program product comprising a computer-readable non-transitory storage medium having computer-accessible instructions (e.g., computer-readable and/or computer-executable instructions) such as computer software, encoded or otherwise embodied in such storage medium. Those instructions can be read or otherwise accessed and executed by one or more processors to perform or permit performance of the operations described herein. The instructions can be provided in any suitable form, such as source code, compiled code, interpreted code, executable code, static code, dynamic code, assembler code, combinations of the foregoing, and the like. Any suitable computer-readable non-transitory storage medium may be utilized to form the computer program product. For instance, the computer-readable medium may include any tangible non-transitory medium for storing information in a form readable or otherwise accessible by one or more computers or processor(s) functionally coupled thereto. Non-transitory storage media can include read only memory (ROM); random access memory (RAM); magnetic disk storage media; optical storage media; flash memory, etc.

Embodiments of the operational environments and methods (or techniques) are described herein with reference to block diagrams and flowchart illustrations of methods, systems, apparatuses and computer program products. It can be understood that each block of the block diagrams and flowchart illustrations, and combinations of blocks in the block diagrams and flowchart illustrations, respectively, can be implemented by computer-accessible instructions. In certain implementations, the computer-accessible instructions may be loaded or otherwise incorporated into onto a general purpose computer, special purpose computer, or other programmable information processing apparatus to produce a particular machine, such that the operations or functions specified in the flowchart block or blocks can be implemented in response to execution at the computer or processing apparatus.

Unless otherwise expressly stated, it is in no way intended that any protocol, procedure, process, or method set forth herein be construed as requiring that its acts or steps be performed in a specific order. Accordingly, where a process or method claim does not actually recite an order to be followed by its acts or steps or it is not otherwise specifically recited in the claims or descriptions of the subject disclosure that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification or annexed drawings, or the like.

As used in this application, the terms “component,” “environment,” “system,” “architecture,” “interface,” “unit,” “pipe,” “module,” and the like are intended to refer to a computer-related entity or an entity related to an operational apparatus with one or more specific functionalities. Such entities may be either hardware, a combination of hardware and software, software, or software in execution. As an example, a component may be, but is not limited to being, a process running on a processor, a processor, an object, an executable portion of software, a thread of execution, a program, and/or a computing device. For example, both a software application executing on a computing device and the computing device can be a component. One or more components may reside within a process and/or thread of execution. A component may be localized on one computing device or distributed between two or more computing devices. As described herein, a component can execute from various computer-readable non-transitory media having various data structures stored thereon. Components can communicate via local and/or remote processes in accordance, for example, with a signal (either analogic or digital) having one or more data packets (e.g., data from one component interacting with another component in a local system, distributed system, and/or across a network such as a wide area network with other systems via the signal). As another example, a component can be an apparatus with specific functionality provided by mechanical parts operated by electric or electronic circuitry that is controlled by a software application or firmware application executed by a processor, wherein the processor can be internal or external to the apparatus and can execute at least a part of the software or firmware application. As yet another example, a component can be an apparatus that provides specific functionality through electronic components without mechanical parts, the electronic components can include a processor therein to execute software or firmware that provides, at least in part, the functionality of the electronic components. An interface can include input/output (I/O) components as well as associated processor, application, and/or other programming components. The terms “component,” “environment,” “system,” “architecture,” “interface,” “unit,” “pipe,” and “module” can be utilized interchangeably and can be referred to collectively as functional elements.

In the present specification and annexed drawings, reference to a “processor” is made. As utilized herein, a processor can refer to any computing processing unit or device comprising single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit (IC), an application-specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. A processor can be implemented as a combination of computing processing units. In certain embodiments, processors can utilize nanoscale architectures such as, but not limited to, molecular and quantum-dot based transistors, switches and gates, in order to optimize space usage or enhance the performance of user equipment or other electronic equipment.

In addition, in the present specification and annexed drawings, terms such as “store,” storage,” “data store,” “data storage,” “memory,” “repository,” and substantially any other information storage component relevant to operation and functionality of a component of the disclosure, refer to “memory components,” entities embodied in a “memory,” or components forming the memory. It can be appreciated that the memory components or memories described herein embody or comprise non-transitory computer storage media that can be readable or otherwise accessible by a computing device. Such media can be implemented in any methods or technology for storage of information such as computer-readable instructions, information structures, program modules, or other information objects. The memory components or memories can be either volatile memory or non-volatile memory, or can include both volatile and non-volatile memory. In addition, the memory components or memories can be removable or non-removable, and/or internal or external to a computing device or component. Example of various types of non-transitory storage media can comprise hard-disc drives, zip drives, CD-ROM, digital versatile disks (DVD) or other optical storage, magnetic cassettes, magnetic tape, magnetic disk storage or other magnetic storage devices, flash memory cards or other types of memory cards, cartridges, or any other non-transitory medium suitable to retain the desired information and which can be accessed by a computing device.

As an illustration, non-volatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The disclosed memory components or memories of operational environments described herein are intended to comprise one or more of these and/or any other suitable types of memory.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

What has been described herein in the present specification and annexed drawings includes examples of systems, devices, and techniques that can provide mobile healthcare management of a subject. It is, of course, not possible to describe every conceivable combination of elements and/or methods for purposes of describing the various features of the disclosure, but it can be recognize that many further combinations and permutations of the disclosed features are possible. Accordingly, it may be apparent that various modifications can be made to the disclosure without departing from the scope or spirit thereof. In addition or in the alternative, other embodiments of the disclosure may be apparent from consideration of the specification and annexed drawings, and practice of the disclosure as presented herein. It is intended that the examples put forward in the specification and annexed drawings be considered, in all respects, as illustrative and not restrictive. Although specific terms are employed herein, they are used in a generic and descriptive sense only and not for purposes of limitation.

What is claimed is:

1. A mobile device, comprising:
a plurality of sensing devices configured to acquire at least one of physiological information indicative of health condition of a subject or situational information indicative of behavior of the subject;
a communication unit configured to receive medical information wirelessly from a remote computing device, the medical information comprising a protocol for health management and a criterion for satisfactory health management; and
a health management client unit functionally coupled to the communication unit and at least one of the plurality of sensing devices and configured to:
control acquisition of one or more of a portion of the physiological information or a portion of the situational information based at least on the protocol for health management, and;
generate a health management response based at least on the protocol for health management and one or more of the portion of the physiological information that is acquired or the portion of the situational information that is acquired.

2. The mobile device of claim 1, wherein the communication unit is further configured to transmit the health management response wirelessly to a remote computing device associated with a care provider for the subject.

3. The mobile device of claim 2, wherein the communication unit is further configured to receive an updated protocol for health management in response to the transmission.

4. The mobile device of claim 1, wherein the communication unit is further configured to transmit wirelessly a request for a product associated with the protocol for health management, and wherein the product comprises one or more of a medication, a food supplement, a medical device, or an exercise machine.

5. The mobile device of claim 1, wherein at least one of the plurality of sensing devices is further configured to acquire at least one of second physiological information or second situational information in response to an event associated with the patient.

6. The mobile device of claim 5, wherein the health management unit is further configured to transmit, to a network platform, at least one of a portion of the second physiological information that is acquired or a portion of the second situational information that is acquired.

7. The mobile device of claim 5, wherein the health management unit is further configured to receive a command to initiate an emergency communication session with a predetermined recipient device in response to presence of the medical emergency condition.

8. The mobile device of claim 7, wherein the health management unit is further configured to initiate the emergency communication session with the predetermined recipient device in response to the command that is received.

9. The mobile device of claim 8, wherein the emergency communication session comprises one or more of a voice call to 911 configured to convey at least information indicative of the medical emergency condition, or
a non-voice communication session configured to convey at least information indicative of the medical emergency condition and location of the patient.

10. A method, comprising:
configuring, at a computing device, a reference patient profile comprising a protocol for episodic care and a criterion for satisfactory episodic care of a patient;
acquiring, at the computing device and according to the protocol for episodic care, at least one of physiological information indicative of health condition of the patient or situational information indicative of behavior of the patient;
generating, at the computing device, a current patient profile based at least on the protocol for episodic care and one or more of a portion of the physiological information that is acquired or a portion of the situational information that is acquired;
comparing, at the computing device, the current patient profile with the reference patient profile;
generating, at the computing device, an episodic care report comprising information indicative of an outcome of the comparing, wherein the outcome of the comparing comprises an indication that the criterion for satisfactory episodic care is satisfied or an indication that the episodic care is not satisfied.

11. The method of claim 10, further comprising transmitting, by the computing device, the episodic care report to a remote computing device associated with a care provider for the patient.

12. The method of claim 11, further comprising receiving, at the computing device, an updated protocol for episodic care in response to the supplying.

13. The method of claim 10, further comprising transmitting a request for a prescription associated with the protocol for episodic care.

14. The method of claim 10, wherein the generating comprises updating an extant patient profile based at least on one or more of the portion of the portion of the physiological information that is acquired or the portion of the situational information that is acquired.

15. The method of claim 10, wherein when the acquiring includes the situational information, the acquiring comprises receiving information indicative of physical activity.

16. The method of claim 10, wherein when the acquiring includes the situational information, the acquiring comprises receiving information indicative of caloric expenditure.

17. The method of claim 10, wherein when the acquiring includes the situational information, the acquiring comprises acquiring information indicative of one or more of type of a foodstuff, a caloric content of the foodstuff, a carbohydrate content of the foodstuff, a fiber content of the foodstuff, nuts content of the foodstuff.

18. The method of claim 10, further comprising acquiring, at the computing device, at least one of second physiological information or second situational information in response to an event associated with the patient.

19. The method of claim 18, further comprising evaluating, at the computing device, at least one of a portion of the second physiological information that is acquired or a portion of the second situational information that is acquired.

20. The method of claim 19, further comprising comparing, at the computing device, an outcome of the evaluating with a second criterion for presence of a medical emergency condition of the patient.

21. The method of claim 19, further comprising initiating, at the computing device, an emergency communication session with a predetermined recipient device in response to an outcome of the comparing indicating presence of the medical emergency condition.

22. The method of claim 19, further comprising initiating, at the computing device, a voice call to 911 in response to an outcome of the comparing indicating presence of the medical emergency condition, the call conveying at least information indicative of the medical emergency condition.

23. The method of claim 19, further comprising initiating, at the computing device, a non-voice communication session with predetermined recipient device, the communication session conveying at least information indicative of the medical emergency condition and location of the patient.

24. A method, comprising:
acquiring, at a computing platform comprising at least one processor, medical information for a population of subjects from a plurality of sources;
aggregating, at the computing platform, at least a portion of the medical information; and
generating, at the computing platform, a reference subject profile for a specific subject of the population of subjects based at least on the portion of the medical information that is aggregated, the reference subject profile comprising one or more of a metric indicative of a health condition of the specific subject, a protocol for episodic care, a criterion for satisfactory episodic care, or a criterion for presence of a medical emergency.

25. The method of claim 24, further comprising communicating the protocol for episodic care to a remote device associated with the specific subject.
